(19) United States
(12) Patent Application Publication
(10) Pub. No.: US 2007/0160400 A1
(43) Pub. Date: Jul. 12, 2007

(54) Sheet post-processing apparatus

(76) Inventors: Hisao Hosoya, Sagamihara-shi (JP); Hiroto Ito, Tokyo (JP)

Correspondence Address: CANTOR COLBURN, LLP, 55 GRIFFIN ROAD SOUTH, BLOOMFIELD, CT, 06002, US

(21) Appl. No.: 11/519,109

(22) Filed: Sep. 11, 2006

(30) Foreign Application Priority Data
Jan. 11, 2006 (JP) JP2006-003395

(51) Int. Cl. G03G 15/00

(52) U.S. Cl. 399/408

(57) ABSTRACT

A sheet post-processing apparatus to eject a recorded sheet, conveyed from an image forming apparatus, into a designated mailing bin, including an intermediate stacking section, arranged inside a housing of the post-processing apparatus, having a stacker to stack the plural recorded sheets conveyed from the image forming apparatus, an alignment section to align the stacked recorded sheets, and a binding device to bind the stacked recorded sheets, a mail storage section, arranged inside the housing of the post-processing apparatus, having at least a mailing bin to receive the sheet whose ejecting destination has been designated, through the intermediate stacking section, a main tray section, arranged outside the housing of the post-processing apparatus, to receive the sheet whose ejecting destination has not been designated, through the intermediate stacking section; and an exclusive door having a key locking mechanism, provided at a position on the housing corresponding to the mail storage section.

This application is based on Japanese Patent Application No. 2006-003395 filed on Jan. 11, 2006, in the Japanese Patent Office, the entire content of which is hereby incorporated by reference.

### TECHNICAL FIELD

The present invention relates to a sheet post-processing apparatus (which is a finisher) to perform post processing on the sheets carrying formed images, and an image forming apparatus.

### BACKGROUND

Since a compound apparatus incorporating an image forming apparatus and a sheet post-processing apparatus has become widely used, developed is an image forming apparatus including a sheet ejecting device, wherein a plurality of trays are used to which the recorded sheets are ejected, and the sheets are grouped based on the clients or the clients group, by which the sheets are ejected to the trays, which are also known as mailing bins (Patent Document 1).

In Patent Document 1, the sheet processing apparatus is described in which a plurality of mailing bins and stackers are provided, and after a guiding member (being a flapper) is switched to each bin or stacker, the sheets are ejected into each mailing bin or stacker. Further, the sheet processing apparatus is also described in which, after a processing station incorporating a book binding device is carried along to the mailing bins and the stackers, which are vertically provided, the processed sheets are ejected into each mailing bin or stacker.

[Patent Document 1] Unexamined Japanese Patent Application Publication No. 2000-7208

According to the post-processing apparatus described in Patent Document 1 incorporating the function of the mailing bins, since the mailing bins are located outside the apparatus, it is not easy to provide a client with security protection of the produced documents left in the mailing bin or the stacker, which is very inconvenient.

### SUMMARY

The invention will now be described.

(1) A sheet post-processing apparatus to eject a recorded sheet, conveyed from an image forming apparatus, into a designated mailing bin, including:

an intermediate stacking section, arranged inside a housing of the post-processing apparatus, having a stacker to stack plural recorded sheets conveyed from the image forming apparatus, an alignment section to align the stacked recorded sheets on the stacker, and a binding device to bind the stacked recorded sheets aligned by the alignment section;

a mail storage section, arranged inside a housing of the post-processing apparatus, having at least a mailing bin to receive the recorded sheet whose ejecting destination has been designated, through the intermediate stacking section;

a main tray section, arranged outside the housing of the post-processing apparatus, to receive the recorded sheet whose ejecting destination has not been designated, through the intermediate stacking section; and

a door section having a key locking mechanism, provided at a position on the housing corresponding to the mail storage section.

(2) A sheet post-processing apparatus to eject a recorded sheet, conveyed from an image forming apparatus, onto a designated mailing bin, including:

an intermediate stacking section, arranged inside a housing of the post-processing apparatus, having a stacker to stack plural recorded sheets conveyed from the image forming apparatus, an alignment section to align the stacked recorded sheets on the stacker, and a binding device to bind the stacked recorded sheets aligned by the alignment section;

a mail storage section, arranged inside the housing of the post-processing apparatus, having at least a mailing bin to receive the recorded sheet whose ejecting destination has been designated, through the intermediate stacking section;

a main tray section, arranged outside the housing of the post-processing apparatus, to receive the recorded sheet whose ejecting destination has not been designated, through the intermediate stacking section; and

a sheet pick-up door having a key locking mechanism, provided on each mailing bin.

(3) A sheet post-processing apparatus to eject a recorded sheet, received from an image forming apparatus, onto a designated mailing bin, comprising:

a sheet pick-up door having a key locking mechanism, provided on the mailing bin;

wherein the recorded sheet is removed after the key locking mechanism is unlocked to open the door.

(4) An image processing system, including:

an image forming apparatus to form an image on a sheet; and

a sheet post-processing apparatus described in (1) to (3), combined with the image forming apparatus.

### BRIEF DESCRIPTION OF THE DRAWINGS

FIG. 1 shows an example of the image forming system including the image forming apparatus and the sheet post-processing apparatus.

FIG. 2 shows the mail storage section and its driving section shown in FIG. 1.

FIG. 3 shows a front view of a part of an outer covering section of the sheet post-processing apparatus.

FIG. 4 shows an example of the fixed-type mailing bins.

### DETAILED DESCRIPTION OF THE PREFERRED EMBODIMENTS

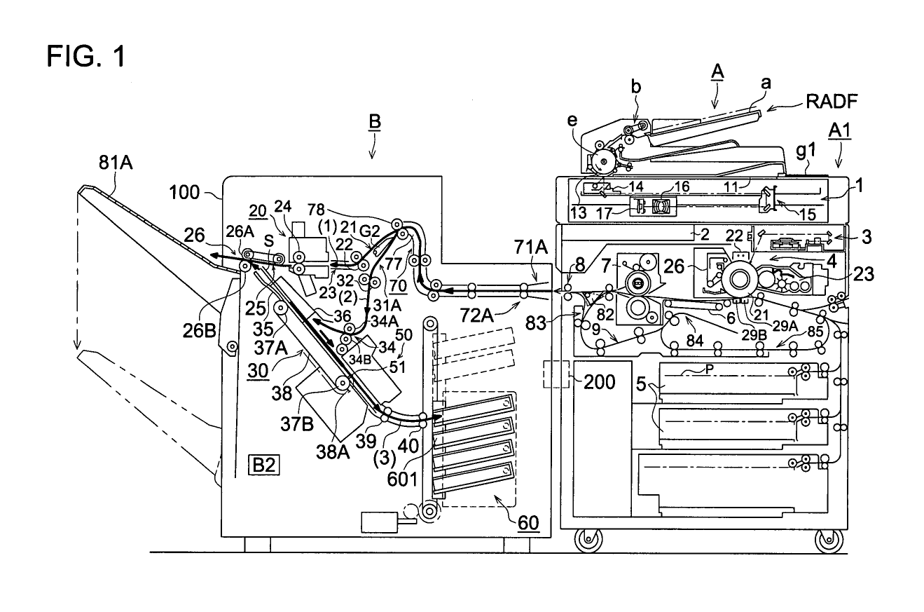

FIG. 1 shows an example of the image forming system including the image forming apparatus and the sheet post-processing apparatus.

In FIG. 1, image forming apparatus A includes automatic double-sided document feeding apparatus RADF and main apparatus A1. The image forming system is connected to external devices, such as a host computer, and is structured to form images based on image data communicated from the external devices.

Automatic double-sided document feeding apparatus RADF, located on main body A1, is openable and closable. An original document placed on original sheet table “a” is conveyed to supply roller “b” and conveyance drum “e”.

Main body A1 is structured of image reading section 1, image processing section 2, image writing section 3, image forming section 4, blank sheet storage tray 5, conveyance section 6, fixing section 7, sheet ejecting section 8 and re-conveyance section 9.

The optical system of image reading section 1 is structured of exposure unit 14 incorporating a light source and a first mirror, V-mirror unit 15 formed of a second mirror and a third mirror, lens 16 and CCD image sensor 17. When exposure unit 14 stops at an initial position which is under slit exposure glass 13, automatic double-sided document feeding apparatus RADF reads the original document. The original document placed on document table glass 11 is read while exposure unit 14 and V-mirror unit 15 are driven. One of several modes is selected via control panel g1, and the selected mode is operated by a control section, which is not illustrated.

Image information of the original document image which is read by image reading section 1 is processed by image processing section 2, and which is changed to electrical signals as digital image data, and is temporarily stored in a memory. Light rays emitted from a semiconductor laser section, which is not illustrated, are radiated onto photoconductive drum 21 serving as a photoconductor, and thereby an electrostatic latent image is formed.

In image forming section 4, the surface of photoconductive drum 21 is electrically charged by charging section 22, and the laser rays, emitted from the semiconductor laser of image writing section 3, is radiated onto the surface of photoconductive drum 21 to form the electrostatic latent image. Next, by developing section 23, the electrostatic latent image is developed by toner into a toner image. The toner image on the drum is then transferred by transferring section 29A onto sheet P conveyed from blank sheet storage tray 5. Sheet P, carrying the transferred toner image, is separated from the surface of photoconductive drum 21 by separating section 29B. After which cleaning section 26 removes any remaining toner from the surface of photoconductive drum 21. Sheet P, carrying the transferred toner image, is conveyed by conveyance section 6 to fixing section 7 to fix the image, and is then conveyed by sheet ejecting section 8 to sheet post-processing apparatus B, provided outside image forming apparatus A.

In addition, in case of double sided copies, sheet P, carrying the formed image on one surface, is conveyed to re-conveyance section 9 by conveyance route changing plate 82, after which sheet P is reversed by sheet reversing section 84, and conveyed by conveyance path 85 to form an image on the opposite surface in image forming section 4, after which sheet P is finally conveyed by sheet ejecting section 8 to sheet post-processing apparatus B provided outside image forming apparatus A. Further when sheet P is reversed and ejected, it is rerouted from an ordinary ejecting route by conveyance route changing plate 82, after which sheet P is switched back at reverse ejecting section 83 to be flipped over to the other surface, and finally sheet P is ejected by sheet ejecting section 8 to sheet post-processing apparatus B provided outside image forming apparatus A.

Next, sheet post-processing apparatus B will be explained. Sheet post-processing apparatus B of the present embodiment includes a staple section. However, a post-processing apparatus not including the staple section, or a post-processing apparatus including a punching section or an adhesive agent coating section, instead of the staple section, can also be structured.

In FIG. 1, sheet post-processing apparatus B includes movable sheet storage plate 81A serving as a main tray section provided outside apparatus B, to stack an ordinary printed sheet or stacked sheets bound on the side, stacking section 30 and staple section (stapler) 50 serving as an intermediate stacking section, and mail storage section 60 relating to the present invention.

In addition, mail storage section 60, incorporated in sheet post-processing apparatus B, is positioned near the combining position of sheet post-processing apparatus B and image forming apparatus A, so that mail storage section 60 (which is mailing bins) is arranged in sheet post-processing apparatus B to be closer to combining section 200 of image forming apparatus A and sheet post-processing apparatus B than movable sheet storage plate 81A (which is a stacker) is to combining section 200. Numeral 100 represents a housing of post-processing apparatus B.

Sheet conveyance routes are indicated by bold arrows in sheet post-processing apparatus B in FIG. 1.

For the installation, sheet post-processing apparatus B is docked to image forming apparatus A in such a way that the height of receiving section 71A of sheet post-processing apparatus B to receive recorded sheet S (sheet P carrying the fixed image is hereinafter referred to as recorded sheet S) from image forming apparatus A, must be adjusted to the height of sheet ejecting section 8 of image forming apparatus A.

The conveyance route of recorded sheet S, which is connected to the downstream with respect to the sheet conveyance direction of paired entrance rollers 72A of receiving section 71A, includes first conveyance route (1) on the upper stage, second conveyance route (2) on the middle stage, and third conveyance route (3) on the lower stage, which is directed to the mail storage section.

Due to the selection of the angle of changeover gate G2, recorded sheet S is conveyed to first conveyance route (1), second conveyance route (2), or third conveyance route (3).

Recorded sheet S conveyed to second conveyance route (2) is further conveyed to either a route toward movable sheet storage plate 81A, or toward third conveyance route (3).

Next, each of the above conveyance routes will be detailed below.

(a) First conveyance route (1), which ejects recorded sheet S to movable sheet storage plate 81A.

When stapling is not selected, as well as the sheet ejection toward the mailing bin is not selected, changeover gate G2 closes route 31A while a solenoid, which is not illustrated, is de-activated, and opens route 21, whereby recorded sheet S can be conveyed by paired conveyance rollers 22.

That is, recorded sheet S, carrying a fixed image, and having been ejected from image forming apparatus A, is conveyed through receiving section 71A, paired entrance rollers 72A, and route 77, after which recorded sheet S is conveyed by paired conveyance rollers 78, and conveyed through route 21 above changeover gate G2, and further conveyed by paired conveyance rollers 22 to first conveyance route (1). Next, recorded sheet S is conveyed through route 23, after which it is nipped and further conveyed by paired conveyance rollers (being paired shift rollers) 24, and conveyed through route 25, and finally ejected outside sheet post-processing apparatus B by paired ejection rollers 26 (which are upper roller 26A and lower roller 26B).

In addition, in the present embodiment, movable sheet storage plate 81A can be shifted upward and downward, and can accommodate a maximum of 3,000 sheets (A4, B5, basis weight of 80 g/m²) of recorded sheets S.

(b) Second conveyance route (2) incorporating a stapling mode, which ejects the sheet to the intermediate stacking section.

When stapling is selected, and the sheet ejection toward the mailing bins is not selected, recorded sheet S, introduced to sheet receiving section 71A of sheet post-processing apparatus B, is conveyed through paired entrance rollers 72A, and route 70, after which it is nipped and conveyed by paired conveyance rollers 78. Further, since the solenoid, which is not illustrated, is activated, changeover gate G2 is switched to open route 31A. Accordingly, recorded sheet S is conveyed through route 31A mounted below changeover gate G2, and is nipped and further conveyed by paired conveyance rollers 32, being downstream of changeover gate G2. Yet further, recorded sheet S is nipped and conveyed by paired conveyance rollers 34 (being drive roller 34A and driven roller 34B), and released near the upper space of stacker 35 of inclined intermediate stacking section 30 so that recorded sheet S comes into contact with the surface of stacker 35, or previously stacked sheet S already on stacker 35, and is further conveyed upward. After the end of recorded sheet S passes paired conveyance rollers 34, recorded sheet S slides downward due to its own weight on the slope of stacker 35, and then the lower end of recorded sheet S comes into contact with movable stopper member (sheet stopping surface) 51 adjacent to stapler section 50, where recorded sheet S stops. (In addition, movable stopper member 51 can rise and set from the conveyance surface, and is set from the surface to convey recorded sheet S to the mailing bins).

Further, subsequent recorded sheets S are also released toward stacker 35 of intermediate stacking section 30 in turn.

Numeral 36 represents movable paired alignment members which are provided on both side of stacker 35. Paired alignment members 36 can move perpendicular to the sheet conveyance direction and parallel the surface of the sheet. When recorded sheet S is to be released toward stacker 35, which is a sheet receiving procedure, paired alignment members 36 are set to be wider than the width of sheet S. When sheet S is to be slipped onto stacker 35 and comes into contact with movable stopper member 51 to be stopped, paired alignment members 36 push on the edges of stacked sheets S to align them (being an alignment of width). When the predetermined number of recorded sheets S have been stacked and aligned on stacker 35 at this stop position, the binding process (being the stapling process) is performed by stapler 50, and the stapling of the stacked sheets S is completed.

A notch is provided on the sheet stacking surface of stacker 35, in which plural looped ejection belts 38 are driven by drive pulley 37A and driven pulley 37B. Ejection crew 38A is integrated to a part of ejection belts 38, and the top of ejection crew 38A moves on a race track excursion shown by a dashed line. The end of stapled recorded sheets S is pushed by ejection crews 38A of ejection belt 38 onto ejection belt 38, and stapled recorded sheets S are sent upward on the slanting stacking surface of stacker 35, after which stapled recorded sheets S are conveyed to a nipping position of paired ejection rollers 26. Stapled recorded sheets S are then nipped by rotating paired ejection rollers 26, and ejected and stacked onto movable sheet storage plate 81A.

(C) Third conveyance route (3), which ejects recorded sheet S to the housed mailing bins.

Concerning the ejection of recorded sheets S to the mailing bin, there are two cases, one is to eject stapled sheets S to the mailing bin, and the other is to eject unstapled sheets S to the mailing bin.

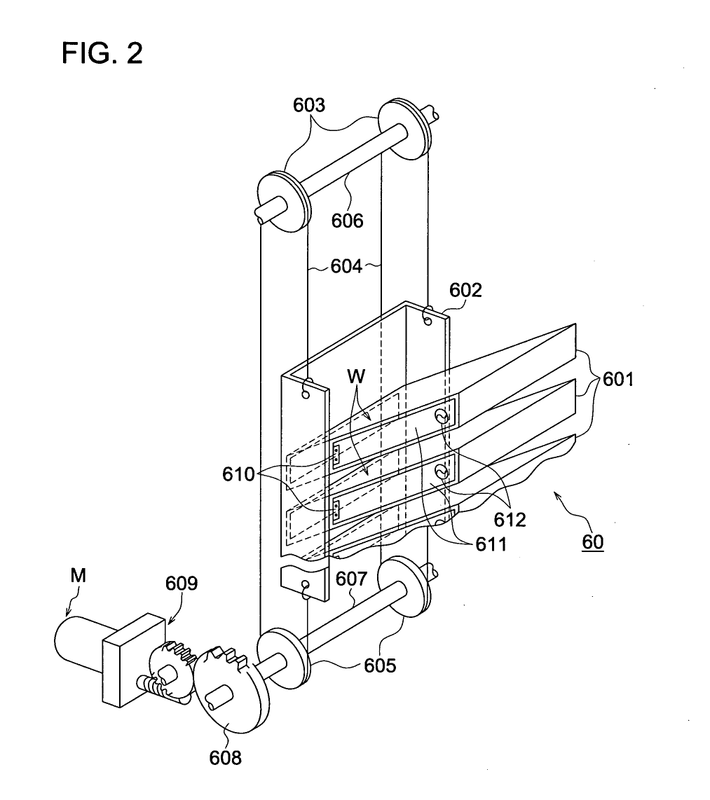

In the former case, the same procedure as described above is conducted until recorded sheets S are stacked on intermediate stacker 35A through second conveyance route (2), and stapled by stapler 50. After the stapling process, the stapled sheets, stopped by movable stopper member 51, slide by their own weight, because movable stopper member 51 has been retracted. Then the stapled sheets S are nipped and conveyed by paired conveyance rollers 39 through third conveyance route (3), and are further delivered to a designated mailing bin 601 (see FIG. 2) by paired mail ejection rollers 40.

In the latter case, after recorded sheets S are released onto intermediate stacker 35 through second conveyance route (2), without being stopped by movable stopper member 51, they slide down through intermediate stacker 35, and are nipped and conveyed by paired conveyance rollers 39 through third conveyance route (3), and delivered to a designated mailing bin 601 by paired mail ejection rollers 40.

According to the structure of the present invention, when a confidential document is to be formed, only a designated person can remove the formed document from the apparatus.

As an example, in the present embodiment, security of the printed document is maintained by such a structure as mailing bins 601 to receive the recorded sheets, or the recorded and stapled sheets provided in the sheet post-processing apparatus, and each mailing bin is locked so that the prepared sheets can not be removed easily. That is, in this structure, only the person who makes the documents, or an assistant who picks up the document for the author of it, can open a lock with a key, and remove the document. Further, when non-secret printed sheets are produced, they are ejected onto movable sheet storage plate 81A, so that image forming operation is not interrupted, and a great number of the recorded sheets S can be continuously produced.

As another example, it is possible to structure a single mailing bin to have a locking mechanism, or a structure in that plural mailing bins are provided, without movable sheet storage plate 81A. Further, the structure is not limited to a structure in which the mailing bin with the locking mechanism is included in the sheet post-processing apparatus, but the structure in that the mailing bins, covered by a box-shaped cover having an openable and closable sheet outlet with a locking mechanism, is provided outside the sheet post-processing apparatus. If the sheet post-processing apparatus incorporates plural mailing bins 601, it is possible to correspond the mailing bins to the user ID for each user or a user ID for several groups including plural users, and both the mailing bins and the user ID are registered. By this corresponding registration, when the image forming system receives the order of image formation from an external host computer, based on the user ID received with the image data, it is possible to automatically divide and eject the image recorded sheets to the designated mailing bins which are registered corresponding to a specific user ID. If no corresponding registration is previously performed, the user determines a mailing bin for the destination, when the user commands the image formation. By this means the image forming system receives information of mailing bin and the image data, and produces the recorded sheets and ejects them to the specific mailing bin. After the user commands the image formation via an external device, the user unlocks the specific mailing bin which is previously registered in correspondence with a user ID, or unlocks the specific mailing bin, after which the user can obtain the produced documents.

Further, the mailing bin can also be opened by the key or specific inputted information of the user ID or inputted information of a password. The user ID or the password can be entered via control panel g1 of image forming apparatus A, or can also be entered via a password input section provided on the door of the mailing bins.

Yet further, in the case of the sheet post-processing apparatus providing only one mailing bin with a key locking mechanism, it is also possible to have a structure in that when the user commands image formation, said user sends the image data as well as an arbitrary password to unlock the mailing bin. The image forming system can also be structured in such a way that the locking mechanism is unlocked when the completed documents are ejected into the mailing bin having the locking mechanism, and when the arbitrary password is inputted via control panel g1 or via the password inputting section provided on the door of the mailing bin. Further, it is also possible to provide a structure in that the locking mechanism of the mailing bin is unlocked when the user ID, which was received with the image data, is inputted via control panel g1 or the password inputting section. When the user ID is used, the designation of an arbitrary password is not necessary for the user, which results in the more advanced operability. In the sheet post-processing apparatus including a single mailing bin, it is also possible to provide a structure in that the locking mechanism is unlocked by a key, and is unlocked by inputting the password or the user ID. However, in this case, only the user having the key can use the mailing bin having the key locking mechanism, therefore control by the user ID or a password is a more convenient structure.

FIG. 2 shows the mail storage section and its driving section, as also shown in FIG. 1.

In FIGS. 1 and 2, mail storage section 60 includes supporting frame 602 to support at least one box-type mailing bin 601, and a driving section to vertically drive supporting frame 602. Each mailing bin 601 has door 611 which is supported by hinge 610 and serves as the sheet pick-up section, and has key locking section 612 which is exclusive for each mailing bin 601.

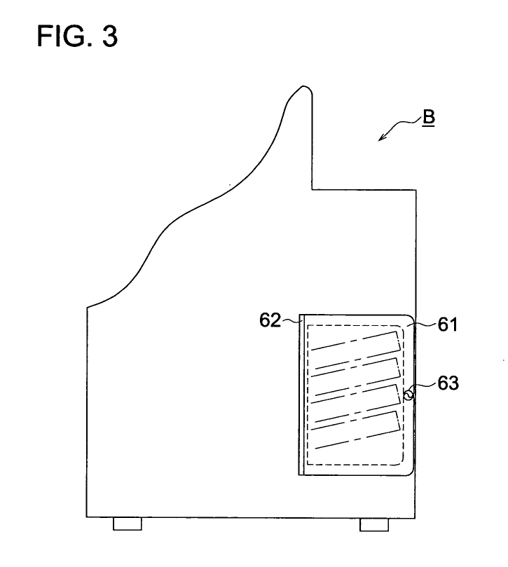

FIG. 3 shows a front view of a part of an outer covering section of the sheet post-processing apparatus.

In FIG. 3, exclusive door 61 with the locking mechanism is provided on a part of the outer covering of the sheet post-processing apparatus, and exclusive door 61, supported by hinge 62, is opened or closed by key 63. That is, in the present embodiment, high document security is obtained, because in FIG. 2, door 611, serving as the sheet pickup door with the key, is provided on each mailing bin 601, and further, in FIG. 3, exclusive door 61, with the locking mechanism, is provided on the outer covering section of the sheet post-processing apparatus. In this case, by employing either exclusive door 61 or doors 611 with the locking mechanism, it is obviously possible to obtain high document security for the user.

Next, the vertical drive of mailing bin 601 will be detailed.

In FIG. 2, both ends of supporting frame 602 are connected to wires 604, which are entrained about pulleys 603 and 605. Paired pulleys 603 and 605 are mounted on rotating shafts 606 and 607, which are supported on a frame, which is not illustrated, of the apparatus. Motor M drives rotating shaft 607 via drive gear 608 and speed reduction section 609. Motor M is driven by the control section of sheet post-processing apparatus B which is controlled by the control section of image forming apparatus A. Pulleys 603 and 605 are rotated by a predetermined angle so that mailing bins 601 are stopped at a predetermined position, into which the designated recorded sheets or stacked sheets are ejected. In addition, supporting frame 602 moves vertically along a guide rail which is not illustrated.

That is, when the image forming command has been sent from an external device connected to the image forming system to the image forming system, the control section of image forming apparatus A specifies a mailing bin to which the user ID and the image data are combined and registered. The control section of sheet post-processing apparatus B receives registered information, and drives motor M to shift specified mailing bin 601 to the position corresponding to paired mail ejection rollers 40. When a specified mailing bin has been designated, the control section of image forming apparatus A sends designated information to the control section of sheet post-processing apparatus B, and sheet post-processing apparatus B drives motor M based on designated information.

Yet further, when the user directly operates image forming apparatus A, but does not operates the external device, the user designates a specified mailing bin by control panel g1. The control section of image forming apparatus A sends information of a designated specified mailing bin to the control section of sheet post-processing apparatus B. The control section of sheet post-processing apparatus B drives motor M to shift designated mailing bin 601 to the position corresponding to paired mail ejection rollers 40.

In addition, supporting frame 602 has openings W corresponding to an entrance of mailing bin 601.

Movable-type mailing bins have been explained above, however, fixed-type plural mailing bins may be also included in the apparatus.

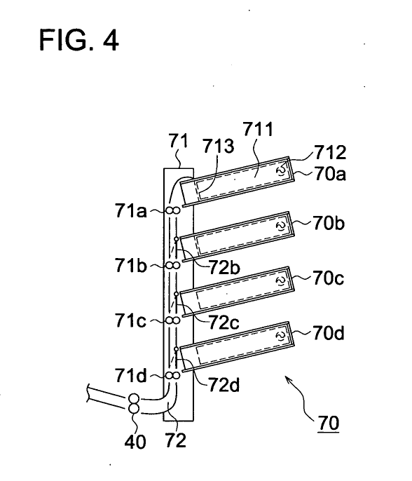

FIG. 4 shows an example of the fixed-type mailing bins.

In FIG. 4, fixed-type mailing bins 70 incorporated in the sheet post-processing apparatus are shown. Mailing bins 70a-70d, having key locking mechanism 712 and door 711 which is supported by hinge 713, are fixed on supporting frame 71 which is mounted on a main body frame of sheet post-processing apparatus B. Supporting frame 71 has delivery guide 72 connected to paired mail ejection rollers 40 (see also FIG. 1). Further, paired conveyance rollers 71a-71d and bin selecting plates 72b-72d are provided in delivery guide 72 near the entrance of each mailing bin. Single recorded sheet or stacked sheets conveyed by paired mail ejection rollers 40 are conveyed to any one of mailing bins 70a-70d which has been designated by the user. For example, when mailing bin 70b has been designated, or another specified mailing bin, which is registered corresponding to a user ID, such as 70b, the stacked sheets are conveyed by conveyance rollers 71d and 71c, and path switching plates 72c and 72d, shown by the solid lines, through delivery guide 72. Next, the stacked sheets reach bin selecting plate 72b shown by dotted lines, and after which delivered to mailing bin 70b by paired conveyance rollers 71b.

By the structures described above, any confidential document can be handled, and client security is maintained.

What is claimed is:

1. A sheet post-processing apparatus to eject a recorded sheet, received from an image forming apparatus, into a designated mailing bin, comprising:
an intermediate stacking section, arranged inside a housing of the post-processing apparatus, having
a stacker to stack the plural recorded sheets conveyed from the image forming apparatus,
an alignment section to align the stacked recorded sheets on the stacker, and
a binding device to bind the stacked recorded sheets aligned by the alignment section;
a mail storage section, arranged inside the housing of the post-processing apparatus, having at least a mailing bin to receive the recorded sheet through the intermediate stacking section, wherein an ejecting destination of the recorded sheet has been designated;
a main tray section, arranged outside the housing of the post-processing apparatus, to receive the recorded sheet through the intermediate stacking section, wherein the ejecting destination of the recorded sheet has not been designated; and
an exclusive door having a key locking mechanism, provided at a position on the housing corresponding to the mail storage section.

2. The sheet post-processing apparatus in claim 1, further comprising a sheet pick-up door having a key locking mechanism on each mailing bin.

3. A sheet post-processing apparatus to eject a recorded sheet, received from an image forming apparatus, into a designated mailing bin, comprising:
an intermediate stacking section, arranged inside a housing of the post-processing apparatus, having
a stacker to stack plural recorded sheets conveyed from the image forming apparatus,
an alignment section to align the stacked recorded sheets on the stacker, and
a binding device to bind the stacked recorded sheets aligned by the alignment section;
a mail storage section, arranged inside a housing of the post-processing apparatus, having at least a mailing bin to receive the recorded sheet through the intermediate stacking section, wherein the ejecting destination of the recorded sheet has been designated;
a main tray section, arranged outside the housing of the post-processing apparatus, to receive the recorded sheet through the intermediate stacking section, wherein the ejecting destination of the recorded sheet has not been designated; and
a sheet pick-up door provided on each mailing bin having a key locking mechanism.

4. The sheet post-processing apparatus in claim 1, wherein the mailing bin is closer to a combining section of the image forming apparatus and the sheet post-processing apparatus than the main tray section is to the combining section.

5. The sheet post-processing apparatus in claim 3, wherein the mailing bin is closer to a combining section of the image forming apparatus and the sheet post-processing apparatus than the main tray section is to the combining section.

6. The sheet post-processing apparatus in claim 1, wherein the mail storage section includes plural mailing bins which move to a sheet receiving position to receive the recorded sheet.

7. The sheet post-processing apparatus in claim 3, wherein the mail storage section includes plural mailing bins which move to a sheet receiving position to receive the recorded sheet.

8. The sheet post-processing apparatus in claim 1, further comprising a bin selecting section to convey the recorded sheet to any one of the plural mailing bins which are fixed in the mail storage section.

9. The sheet post-processing apparatus in claim 3, further comprising a bin selecting section to convey the recorded sheet to any one of the plural mailing bins which are fixed in the mail storage section.

10. A sheet post-processing apparatus to eject a recorded sheet, received from an image forming apparatus, onto a designated mailing bin, comprising:
a sheet pick-up door having a key locking mechanism, provided on the mailing bin;
wherein the recorded sheet is removed after the key locking mechanism is unlocked to open the door.

11. The sheet post-processing apparatus in claim 1, wherein the key locking mechanism is unlocked after a password, which is previously registered corresponding to each mailing bin, is inputted.

12. The sheet post-processing apparatus in claim 3, wherein the key locking mechanism is unlocked after a password, which is previously registered corresponding to each mailing bin, is inputted.

13. The sheet post-processing apparatus in claim 10, wherein the key locking mechanism is unlocked after a password, which is previously registered corresponding to each mailing bin, is inputted.

14. The sheet post-processing apparatus in claim 1, wherein the key locking mechanism is unlocked after a user ID or a password, which are received with image data, is inputted.

15. The sheet post-processing apparatus in claim 3, wherein the key locking mechanism is unlocked after a user ID or a password, which are received with image data, is inputted.

16. The sheet post-processing apparatus in claim 10, wherein the key locking mechanism is unlocked after a user ID or a password, which are received with image data, is inputted.

17. An image processing system, comprising:
an image forming apparatus to form an image on a sheet; and
the sheet post-processing apparatus in claim 1, combined with the image forming apparatus.

18. An image processing system, comprising:
an image forming apparatus to form an image on a sheet; and
the sheet post-processing apparatus in claim 3, combined with the image forming apparatus.

19. An image processing system, comprising:
to form an image on a sheet; and
apparatus in claim 10, apparatus.
